(19) United States
(12) Patent Application Publication
(10) Pub. No.: US 2016/0219134 A1
(43) Pub. Date: Jul. 28, 2016

(54) MOBILE DEVICE CASE WITH SOUND RADIATOR

(71) Applicant: TJ Cameron, Brandon, SD (US)

(72) Inventor: TJ Cameron, Brandon, SD (US)

(21) Appl. No.: 14/606,801

(22) Filed: Jan. 27, 2015

(51) Int. Cl. H04M 1/02; H04R 1/28

(52) U.S. Cl. CPC H04M 1/026; H04R 1/2807; H04R 2499/11

(57) ABSTRACT

Mobile device cases feature sound radiators for changing the sound characteristics of audio played from a mobile device's speakers. The cases may comprise a mobile device enclosure and a barrier that defines a sound input opening and divides the mobile device enclosure into a device portion and a radiator having a radiator floor. The radiator may include a sound wall and a side wall extending from the radiator floor and defining a sound output opening that is acoustically coupled to the sound input opening.

### FIELD

The present disclosure relates to cases for mobile devices having sound radiators for directing, amplifying, or otherwise changing the sound characteristics of audio sound waves transmitted from a mobile device's speakers.

### BACKGROUND

Most mobile devices have speakers for producing sound, but device manufacturers often compromise sound quality for cost, device size, and other design considerations. For example, a mobile device may have a small, mono speaker on the bottom of the device that projects sound in a direction substantially parallel to the device. While this configuration may be beneficial in some circumstances, users often desire a higher-quality sound experience.

### SUMMARY

Implementations of a case for a mobile device may include a mobile device enclosure comprising a pair of adjacent side walls coupled by a pair of adjacent end walls defining a substantially elongate rectangular opening configured to receive a mobile device. An end wall of the pair of end walls may define a sound input opening. A sound radiator may be coupled to the mobile device enclosure proximate this end wall defining the sound input opening. The radiator may include components such as side walls, shoulders, a sound wall and a radiator floor. A first end of the radiator side walls may extend perpendicularly relative to the end wall defining the sound input opening. The shoulders may extend from a second end of the radiator side walls. The sound wall may be joined between the shoulders and arranged opposite the end wall defining the sound input opening. The radiator floor may define a cover such that the radiator components define a partial enclosure for receiving and directing sound waves. The side walls and the sound wall together may define a sound output opening acoustically coupled to the sound input opening for transmitting sound waves out of the partial enclosure.

One embodiment of a case for a mobile device may include a mobile device enclosure and a barrier defining a sound input opening that divides the mobile device enclosure into a device portion and a radiator having a radiator floor. The radiator may include a sound wall and a side wall extending from the radiator floor that define a sound output opening acoustically coupled to the sound input opening. The case may also have a hinge that divides the case into a first section and a second section and a hinge discontinuity located substantially between the first and second sections. The hinge may also define a first position where the first and second sections are substantially parallel and a second position where the first and second sections are not substantially parallel. The radiator may be slidably coupled to the mobile device enclosure near the sound input opening to define a first position where the sound wall is further away from the speaker opening than it is in a second position.

In another embodiment, there may be a radiator comprising a radiator floor and, extending therefrom, a sound wall and a side wall; a sound input opening and a sound output opening defined by the sound wall, side wall, and radiator floor; and one or more connection members for coupling the radiator to a mobile phone enclosure so that the sound input opening is located near a speaker opening in the mobile phone enclosure. The sound output opening may be larger than the sound input opening.

In various embodiments, the radiator floor may have an increased height near a portion where the walls extend from the radiator floor; the height of the radiator floor may be equal to a height of the walls; the radiator floor may be made from a different material than the other components of the radiator; the radiator floor may be constructed from a resonant material; the radiator floor may extend partially into the phone enclosure; the radiator may be detachable from the phone enclosure; other configurations; or combinations thereof.

### BRIEF DESCRIPTION OF THE DRAWINGS

For a further understanding of the above and other features and advantages, reference is made to the following detailed description and to the drawings, in which:

FIG. 1A illustrates a perspective view of a mobile device case having a sound radiator, according to certain implementations;

FIG. 1B illustrates a second perspective view of the mobile device case of FIG. 1A;

FIG. 2 illustrates a top view of a mobile device case having a sound radiator according to certain implementations;

FIG. 3 illustrates an end view of a mobile device case having a sound radiator according to certain implementations;

FIG. 4A illustrates a side cutaway view of a mobile device case having a sound radiator according to certain implementations;

FIG. 4B illustrates a side cutaway view of a mobile device case having a sound radiator according to certain implementations;

FIG. 5 illustrates a rear view of a mobile device case having a sound radiator according to certain implementations;

FIG. 6 illustrates a side view of a mobile device case having a sound radiator according to certain implementations;

FIG. 7 illustrates a second side view of the mobile device case having a sound radiator opposite the side view of FIG. 6;

FIG. 8 illustrates an end view of a mobile device case having a sound radiator according to certain implementations;

FIG. 9 illustrates a perspective view of a mobile device case having a sound radiator according to certain implementations;

FIG. 10 illustrates a perspective view of a mobile device case having a sound radiator according to certain implementations;

FIG. 11 illustrates a side view of the mobile device case of FIG. 10;

FIG. 12 illustrates an end view of the mobile device case of FIG. 10;

FIG. 13A illustrates a perspective view of a mobile device case having a sound radiator in a first deployed position according to certain implementations; and

FIG. 13B illustrates a perspective view of the mobile device case of FIG. 13A with the sound radiator in a second retracted position.

### DETAILED DESCRIPTION

Implementations provide mobile device cases with a sound radiator. The following embodiments may include configurations with a mobile device having a speaker on its bottom edge; however, other embodiments of a mobile device case may be configured for use with devices of different sizes, shapes, and speaker configurations than the one described. The embodiments may be directed to and suitable for various kinds of mobile devices including but not limited to cell phones, tablet computers, laptops, smart watches, and other mobile devices.

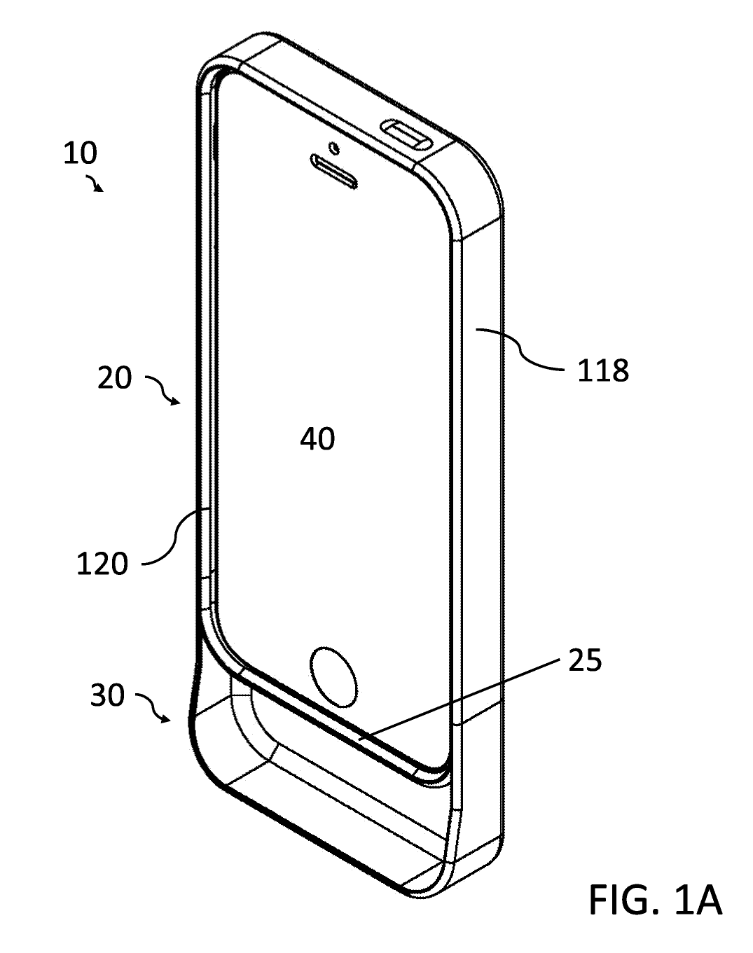

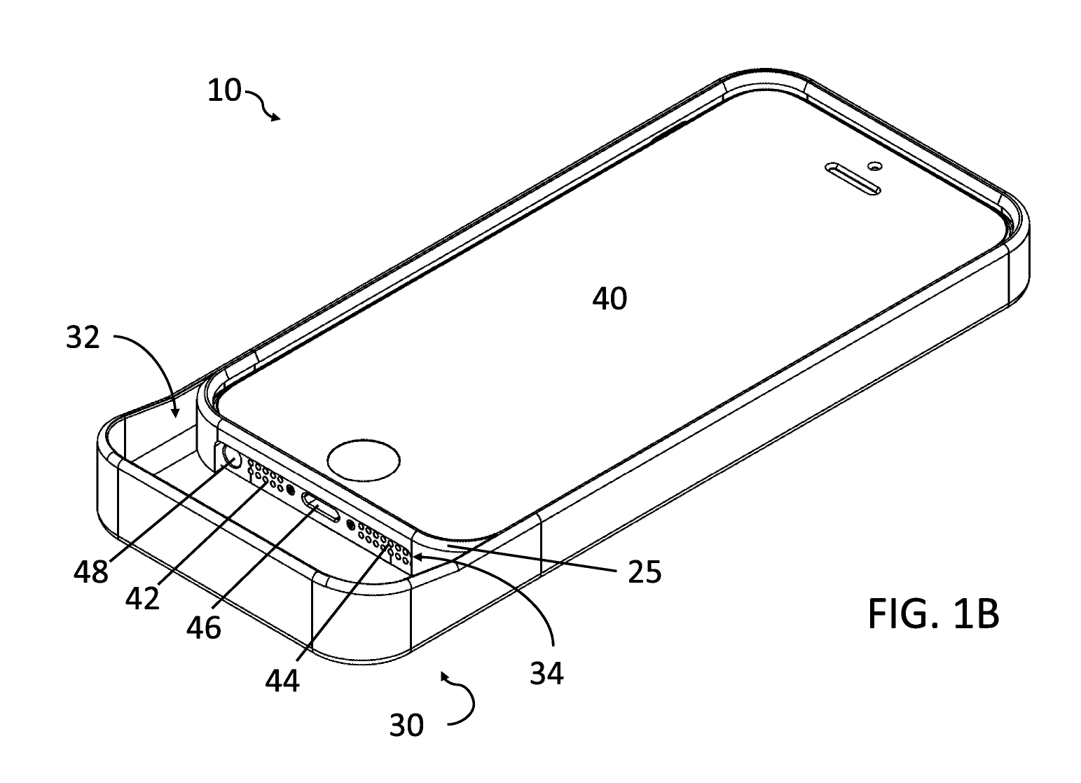

FIG. 1A illustrates a perspective view of an embodiment of a mobile device case having a sound radiator in a first configuration. The case 10 is shaped and sized to receive and retain a mobile device 40 in a mobile device portion 20. The mobile device portion 20 may be separated from a radiator 30 by a barrier 25, and the mobile device portion 20 may be configured to provide protection to the device 40 while allowing a user to access a screen of the device 40 or various controls that may be present. The radiator 30 may be configured to modify the sound produced by the mobile device 40, and may, for example, modify volume, directionality, equalization, other acoustic properties, and combinations thereof. The radiator may be passive and not require a power source to function as a sound modifier. The radiator may be positioned substantially on a same plane as the device 40, however other configurations are possible. In some embodiments, a ratio of width to length of the radiator 30 may be 3:1; however, other configurations are possible.

The mobile device portion 20 may be defined by, for example, a mobile device enclosure 118 sized and shaped to surround a periphery of the mobile device 40 (for example, one or more of the sides, back, front or other regions). The enclosure 118 may allow for the mobile device portion 20 to protect and retain the mobile device 40 within the mobile device portion 20. Various features may be provided for receiving and retaining the mobile device 40 within the mobile device portion 20, including but not limited to: mobile device retention clips, portions for protecting the mobile device, rubberized grip portions, mobile device retention locks, other mobile device protection means and combinations thereof. For example, a lip 120 may extend along the periphery of the mobile device enclosure 118 for retaining the mobile device 40. The lip 120 may be configured as a flange or other structure that prevents the mobile device portion 20 from releasing mobile device 40 during regular use. In addition, the lip 120 may cooperate with a back plate or mobile device base 140 (not visible in FIG. 1A) to restrict motion of the mobile device 40.

FIG. 1B illustrates a second perspective view of the case 10 of FIG. 1A, including the barrier 25. The barrier 25 may be configured to expose various regions at an end of the mobile device 40, for instance, a speaker 42, a microphone 44, a port 46, and an audio connector 48 or various other components. The speaker 42 and the microphone 44 of the mobile device 40 may be located behind speaker grilles to protect internal sound components. The barrier 25 may be constructed so as to not interfere with the use or access of these components 42, 44, 46, 48 while providing retention, support, and/or protection to the mobile device 40. For example, in this embodiment, portions of the barrier 25 extending between the first and second side walls of the mobile device portion 20 include curved regions complementary to a curvature of the side walls of the mobile device 40, a top portion of the barrier 25 may be complementary to a top part of the mobile device 40, and the barrier 25 defines an opening configured as an input opening 34 for the use and access of components 42, 44, 46, 48 located on the bottom of the mobile device 40. The input opening 34 may provide a conduit for transmitting sound between the device portion 20 and the radiator 30 and may deliver or input sound waves into an interior of the radiator 30. The speaker 42 of the mobile device 40 may act as a driver for the propagation of sound waves within radiator 30 and out of a radiator sound opening 32 defined by side walls of the radiator. The radiator sound opening 32 may enable sound waves to be output from the radiator 30.

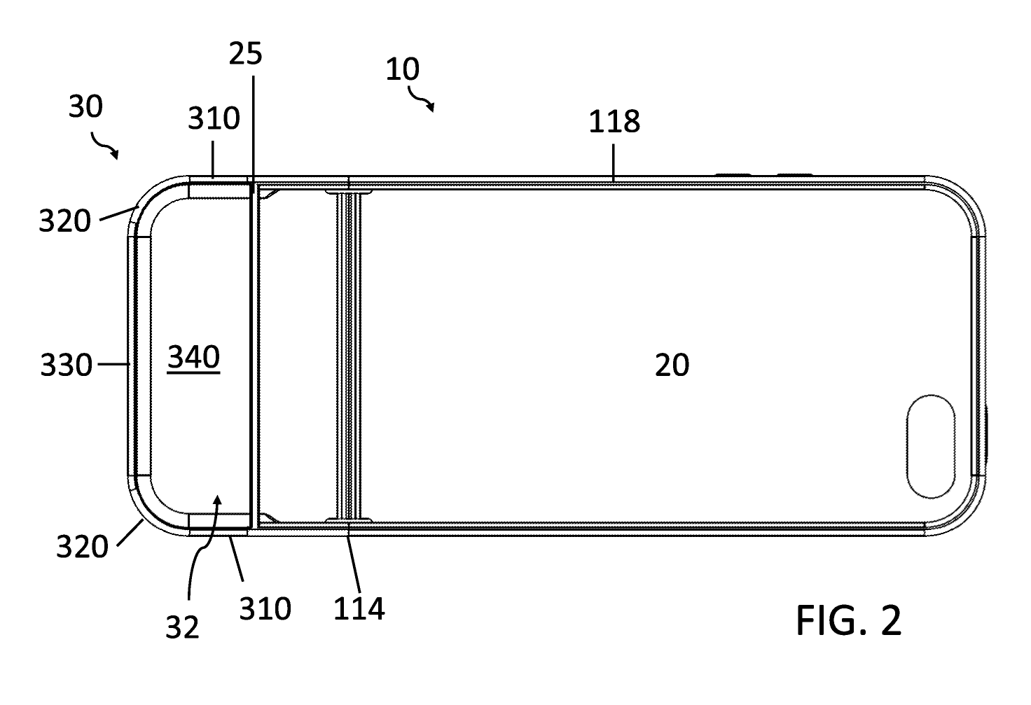

FIG. 2 illustrates a front view of the case 10, including the radiator 30 and without mobile device 40, according to certain implementations. The radiator 30 may include radiator side walls 310, shoulders 320, a sound wall 330, and a radiator floor 340. These components, 310, 320, 330, 340 may define the radiator sound opening 32. The components 310, 320, 330, 340 may be configured to channel, direct, acoustically couple, or amplify sound waves from the sound input opening 34 (not shown) towards, though, and/or out the radiator opening 32. The radiator side wall 310 may be a wall region of the radiator 30 that begins at a hinge discontinuity 114 and ends at or is coupled to one of the shoulders 320. In some embodiments, the radiator side wall 310 may initiate at the barrier 25 or other portions of the enclosure 118. The radiator side walls 310 may define the width of the radiator 30. In certain implementations, the radiator side walls 310 may be substantially in-line with and/or substantially parallel to the side walls of the device portion 20. In other implementations, the radiator side walls may extend at an angle in order to define a radiator 30 having a portion of greater or smaller width than the width of the device retention portion 20.

The shoulder 320 may be a transition region between the radiator side wall 310 and the sound wall 330. In the illustrated embodiment, the shoulder 320 is a curved wall region; however, in other embodiments, the shoulder 320 may define sharper or more gradual transition. The sound wall 330 may be the wall of the radiator 30 arranged between the shoulders 320. Depending on the configuration of the mobile device 40 and the radiator 30, the sound wall 330 may be opposite the barrier 25 and the sound input opening 34. In this location, it may be advantageous for the sound wall 330 to have special properties to increase the propagation and amplification of sound being emitted from the speaker 42 or being channeled into the microphone 44, when the mobile device 40 is installed in the mobile device portion 20.

Different implementations of the radiator side walls 310, the shoulders 320, and the sound wall 330 may have differing thicknesses and/or heights. These portions may have characteristics similar to or different from each other. According to one implementation, one or more of these components 310, 320, 330 may have substantially the same thickness as the side walls of the mobile device portion. In other implementations, one or more of these components 310, 320, 330 may be thicker or thinner than the side walls of the mobile device portion in order to produce or encourage particular sound characteristics of the radiator 30.

The interior region of the radiator 30 and the various components within may have or be designed to create various characteristics and features in order to achieve desired acoustic properties. For example, the radiator 30 may be shaped so as to improve the propagation of sound waves from the sound input opening 34 or to the microphone 44. In one implementation, the radiator floor 340 may have a chamfered edge transition with the sound wall 330, shoulder 320, side walls 310, combinations thereof, or portions thereof. This chamfered edge may allow for the encouragement of sound propagation from sound input opening 34 to the radiator sound opening 32. The height of this change may be four-times the height of the thickness of radiator floor 340, however, other configurations are possible. For example, the chamfer may extend substantially all of the way up the walls of the radiator 30 and substantially all of the way along the floor 340 towards a portion near the barrier 25. The floor 340 may also have specific channels or routes to encourage the transmission of sound from the sound input opening 34 to the sound opening 32.

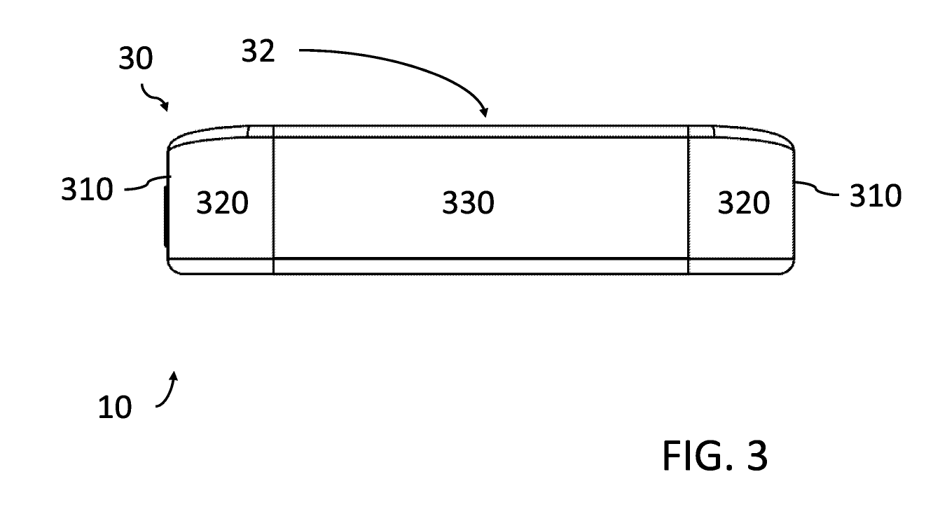

FIG. 3 illustrates an end view of the case 10, including the sound wall 330 and shoulders 320, according to certain implementations. The walls 310, 320, 330 of the radiator 30 may be relatively straight or perpendicular to the floor of the case 10. In some embodiments, the walls 310, 320, 330 of the radiator 30 may bow or flare out to form a horn-shaped or other structure. For example, such a design may result in the radiator sound opening 32 having a larger or smaller area than the area of the radiator floor 340 (not shown in FIG. 3) within the radiator 30. This design may alter the acoustic properties of the radiator 30. The sound wall 330, shoulder 320, radiator side walls 310, radiator floor 340, and barrier 25 may define an enclosed or partially enclosed radiator interior region, including the radiator sound opening 32. From this perspective, it can be seen that the top portion of the radiator 30 has a gentle curve in the shoulder 320 region but flattens out near the sound wall 330 portion. However, other embodiments of the case 10 may have different configurations. For example, the sound wall 330 and the shoulder 320 may define a horn-shaped region in the radiator 30 or a region that flares outward from the radiator sound opening 32.

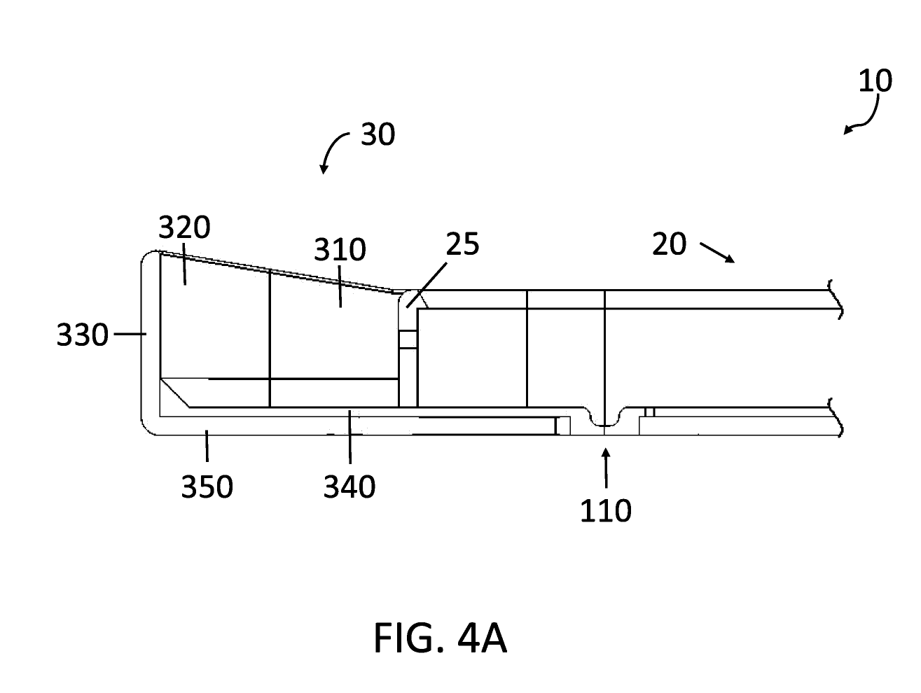

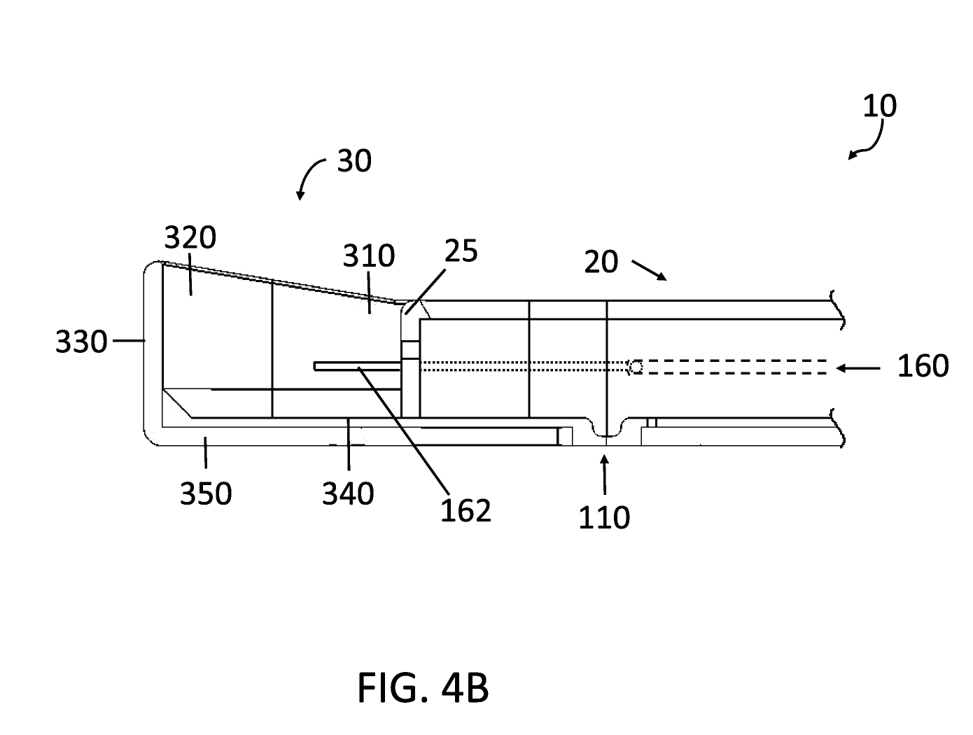

FIG. 4A illustrates a side cutaway view of the case 10, including the sound wall 330 and shoulders 320, according to certain implementations. While the height of portions of the radiator side wall 310 and the shoulder 320 are consistent with height of the wall of the mobile device portion 20, other portions have an increasing height. For example, the increase in height may be a 25% increase in height, but other increases or decreases are possible. This increase in height may be linear, as shown, or may follow non-linear paths. This view also illustrates the presence of chamfered edges on the periphery of the case 10. These edges may make the case 10 more comfortable to hold than a sharp transition between different portions of the case 10.

The radiator floor 340 may be constructed from the same material as the rest of the radiator 30 and, in some embodiments, may be optional or integrally coupled with a radiator base 350. In other embodiments, the radiator floor 340 may be constructed from a different material than other portions of the case 10 in order to improve the acoustic properties of the radiator 10. For example, the radiator floor 340 may be a stiff section prone to vibrating or resonating when the mobile device 40 produces sound. This vibration may improve the acoustic properties of the produced sound.

The radiator floor 340 may be substantially flat and abut sound wall 330, shoulder 320, and radiator side walls 310 at a substantially 90-degree angle. However, the radiator floor 340 may have curved regions, regions of increased material, regions of increased density, regions of different materials, channels, bumps, other structural components, or combinations thereof. The height of the radiator 30 may vary. For example, the radiator 30 may linearly increase in height from about the barrier 25 to the sound wall 330. However, other configurations are possible. For example, the change in height may be constant, varied, curved, non-existent, or other configurations.

FIG. 4B illustrates case 10 configured with a sliding fit between the radiator 30 and the device enclosure 20 by a groove 160 and a tongue 162, according to certain implementations. The groove 160 may be a channel or groove cut into a portion of the case 10 to allow a sliding fit for a tongue 162 located on a portion of the radiator 30. The tongue 162 may be a protrusion or other extension that may substantially align with the groove 160. This configuration may allow for radiator 30 to have a sliding fit with the rest of the case 10. It may also allow for the radiator 30 to be removed from the case 10 entirely. There may be various locking features that may resist movement of the radiator 30 at various portions, including just before removal, at positions conducive to particular sound or ergonomic configurations, and other positions. For example, there may be a position where the sound wall 330 (or other potion of the case 10) abuts the mobile device 40 or the barrier 25 so as to substantially mute or muffle sound emitted from mobile device 40. While this particular embodiment is shown as having a tongue-and-groove sliding fit, other configurations are possible. For example, the radiator 30 may have radiator side walls 310 sized to fit within or around the mobile device portion 30.

In addition, certain implementations of case 10 may have both a hinge 110 and a tongue-and-groove. For example, the tongue 162 may end in a pin, ball, or other substantially circular portion that may have rotatably fit within the groove 160. When the radiator 30 is, for example, fully extended, the pin may enable the radiator 30 to rotate at the hinge 110. For example, hinge 110 may deform to allow motion or rotation by the pin. In other embodiments, the tongue 162 may leave the groove 160 to allow for rotation at the hinge 110. The groove 162 may also be curved along the path of rotation that would result by bending at hinge 110. Other combinations or structures are possible as well.

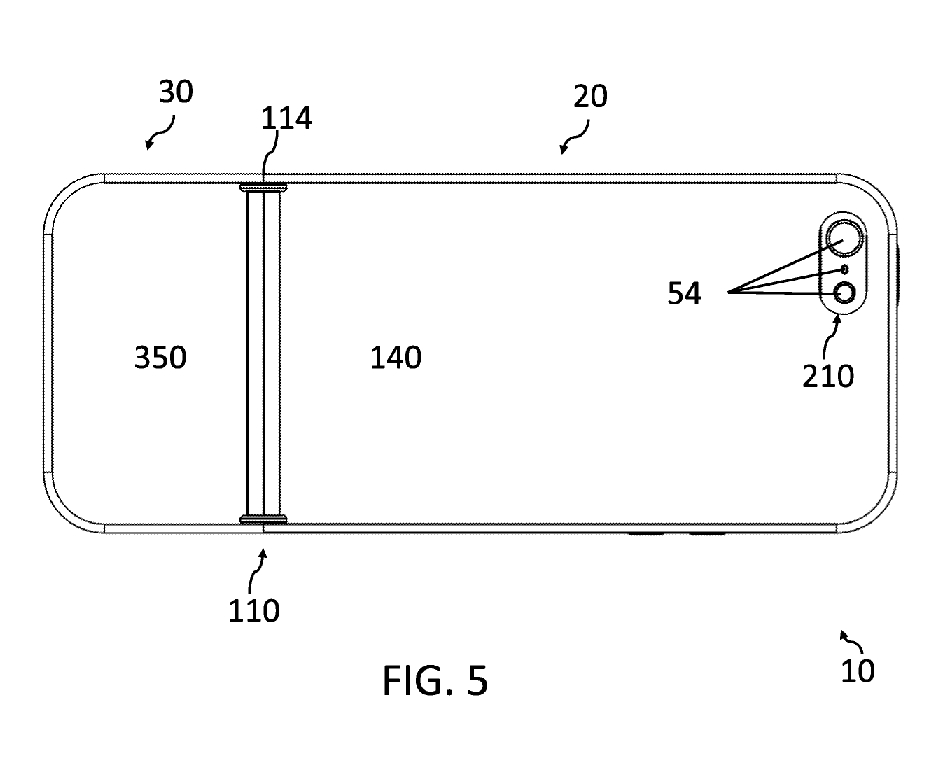

FIG. 5 illustrates a rear view of the case 10 having a sound radiator according to certain implementations, including the hinge 110 and a hinge discontinuity 114. The hinge 110 may divide the back of the case 10 into a mobile device base 140 and the radiator base 350 and may be a pivot point at or by which the mobile device base 140 and the radiator base 350 may pivot or rotate. The back of the case 10 may also be divided by the hinge discontinuity 114. The hinge discontinuity 114 may be an area lacking material, an area of highly stretchable material, or a region that generally cooperates with the hinge 110 to allow for hinged separation between two portions of the case 10. Although the hinge 110 is illustrated as being located in the mobile device portion 20, it may be located in other areas along case 10. Some embodiments may not include the hinge 110. In one embodiment, the hinge 110 may be constructed from the same material as the radiator floor 340. In other embodiments, the hinge 110 may be entirely or partially constructed from a stretchy or material conducive to repeated bending to allow the mobile device 40 to bend at the hinge discontinuity 114. The hinge 110 may have a divot or recessed portion to encourage movement or bending.

The mobile device base 140 may be a portion of the case 10 that primarily defines a back section of the mobile device portion 20 and may be configured with a generally planar wall with a shape corresponding to the back section of the mobile device 40. The mobile device base 140 may define a rear component opening 210. The rear component opening 210 may correspond to a rear component portion 54 of the mobile device 40 when the mobile device 40 is retained in the mobile device portion 20. The rear component opening 210 may allow use of or provide access to rear component portions 54, which may include cameras, speakers, lights, batteries, other features, or combinations thereof. The radiator base 340 may be a portion of the case 10 that primarily defines a back section of the radiator 30 and may extend to cover a back section of the mobile device portion 20.

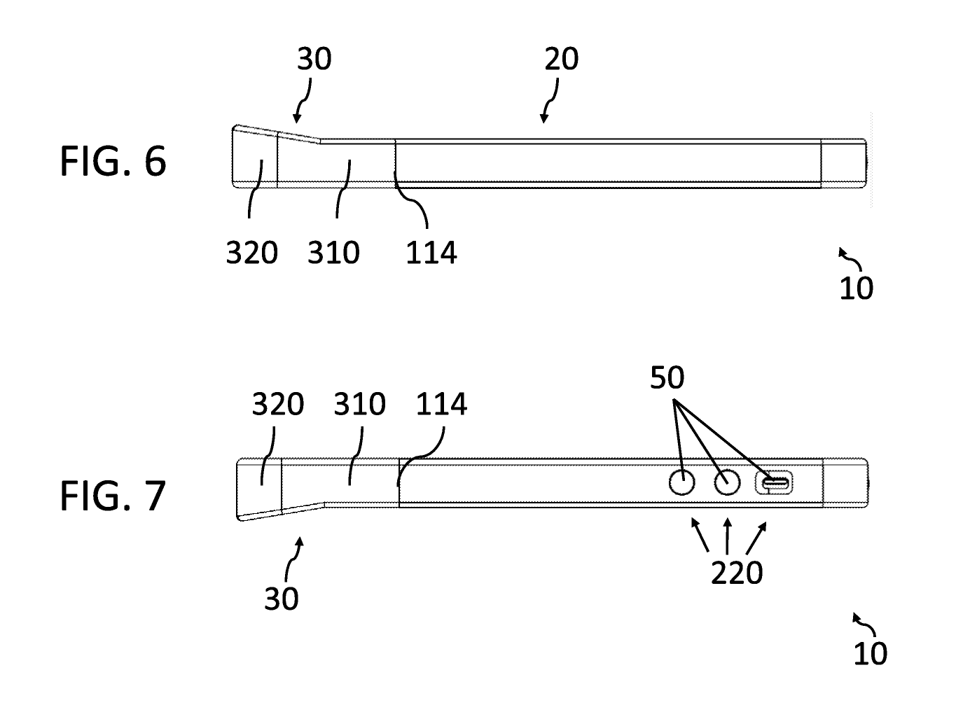

FIG. 6 illustrates a side view of the case 10, including the radiator 30, according to certain implementations. The case 10 may have a height that varies across its length. For example, the mobile device portion 20 may have a relatively consistent height, the radiator 30 may have a height that matches the height of the mobile device portion 20, and the radiator 30 may have a region of increasing height. For example, as the radiator side walls 310 extend away from the mobile device portion 20, the radiator side walls 310 may have a substantially similar height to the height of the side walls of the mobile device portion 20. As the radiator side walls 310 continue to extend, the height of the radiator side walls 310 may increase. This increase in height may continue through shoulder 320 and sound wall 330. The increase in height may be fixed or adjustable. According to one implementation, portions of the sound wall 330, shoulders 320, and side walls 310 may be constructed from a material or combination of materials that allow for the increase in height to be adjusted. In addition, FIG. 6 illustrates the hinge discontinuity 114 as it extends up the side of the case 10.

FIG. 7 illustrates a second side view of the case 10 opposite the side view of FIG. 6, including a feature opening 220, according to certain implementations. The feature opening 220, may be one or more openings located on a side of the case 10 to allow a user to access a side mobile device feature 50 located on a side of the mobile device 40. The side mobile device features 50 may include a silent-mode switch, volume buttons, power buttons, a kick stand, SIM card door, and other features. Although the feature openings 220 are shown as being discrete openings for each of the side mobile device features 50, the feature opening 220 may be a single continuous opening that allows for access to many or all of side mobile device features 50. While the openings 220 may be an absence of material in the side of a case 10, the openings 20 may also be a different material that allows for manipulation of the side mobile device features 50 (for example, a region of thinner or different material), and depending on the material the case 10 is made from, openings may not be needed at all.

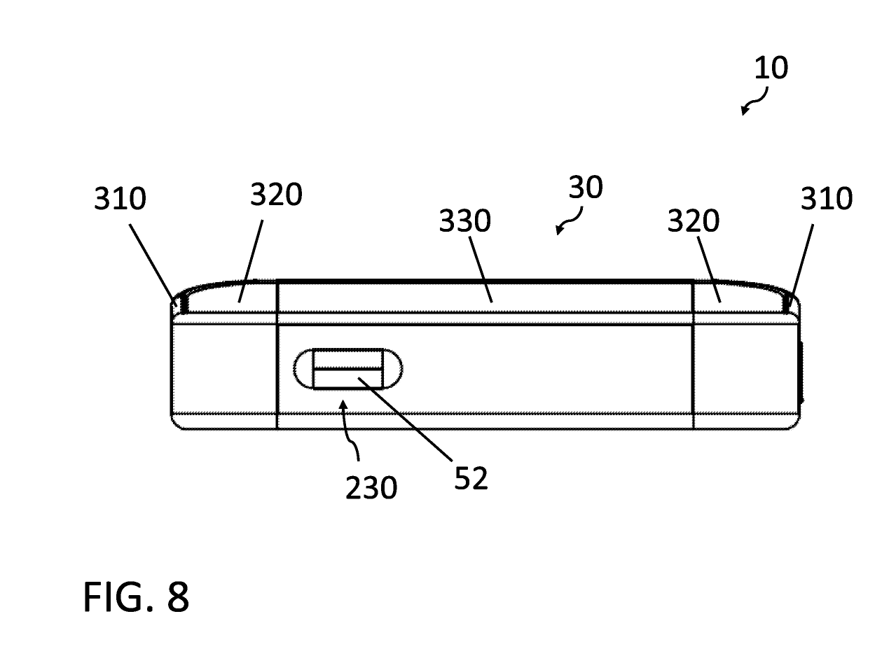

FIG. 8 illustrates an end view of case 10, including a top feature opening 230 according to certain implementations. The top feature opening 230 may be one or more openings located on a top of the case 10 to allow for a user to access one or more of the top features 52 located on a top of the mobile device 40. The top features 52 may include a power button, a SIM card door, a headphone jack, and other features. Although the top feature opening 230 is shown as a single continuous opening that allows for access to the top feature 52, other openings, or configurations of openings are possible. While the opening 230 may be an absence of material in the top of the case 10, the opening 230 may also be a different material that allows for manipulation of a top feature 52 (for example, a region of thinner or different material), and depending on the material the case 10 is made from, the opening 230 may not be needed at all. In addition, the portions of the radiator 30 that have a greater height than the phone retention portion 20 are visible, specifically side walls 310, shoulders 320, and sound wall 330.

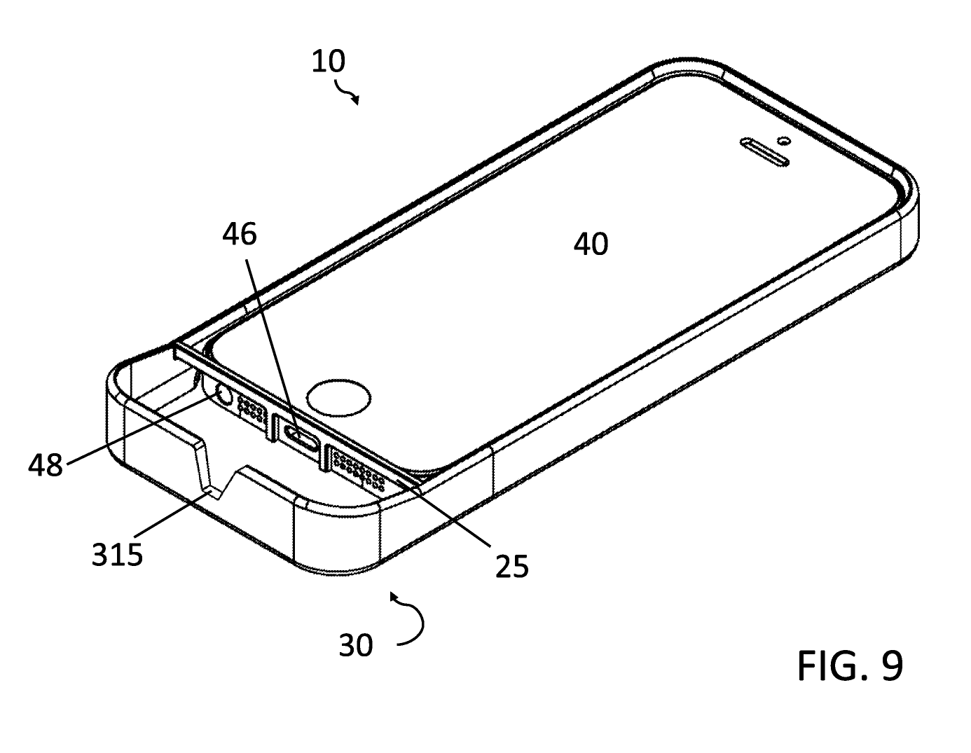

FIG. 9 illustrates a perspective view of case 10 having an alternate barrier 25 design according to certain implementations. In this implementation, the barrier 25 is a substantially straight, elongate piece extending across the width of case 10 with two posts coupling the barrier 25 to the floor of the case 10. The exact location of the posts may vary depending on the configuration of the mobile device 40. For example, as illustrated, the posts flank the port 46 but do not cover other features 42, 44, 48 on the base of the mobile device 40. In this implementation, sound input opening 34 may be smaller than in other implementations. The illustrated case 10 also has a notch 315. The notch 315 may be an opening defined by a portion of the case 10 (e.g., sound wall 330) sized, shaped, and located in order to provide additional access to components of the mobile device 40, such as the port 46 or the audio connector 48. A device designed to connect to the port 46 (e.g., a charging or data cable) may be of such a size and shape that a user may have difficulty coupling the device with the port 46. The notch 315 may be configured to facilitate the process by, for example, providing additional space to maneuver or place the device. In addition, the notch 315 may be sized, shaped, and/or located to minimize an effect on the radiator 30. For example, if the notch 315 is too large, it may encourage sound propagation in an undesirable manner. In other implementations, the notch 315 may be designed to affect the performance of the radiator 30. The notch may be sized, shaped and/or located in order to beneficially alter the sound propagation characteristics of the radiator 30. For example, implementations with the notch 315 may alter the directionality of audio in a desired direction.

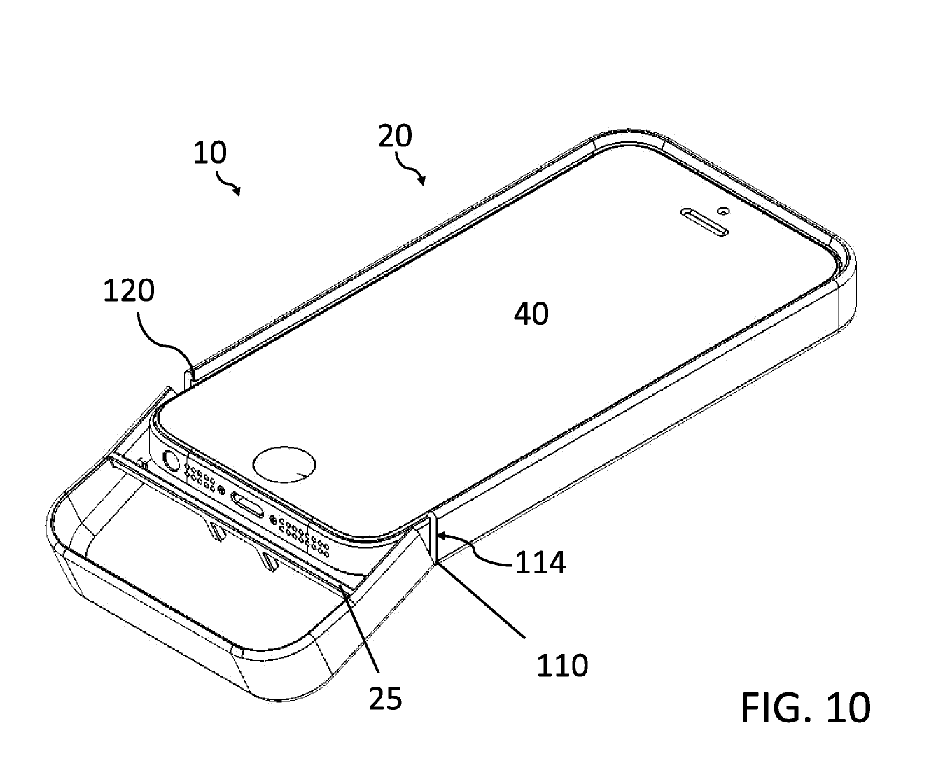

FIG. 10 illustrates a perspective view of the case 10 according to certain implementations. The case 10 may be positioned in the second configuration by bending the case 10 at the hinge 110 and the hinge discontinuity 114. Bending the phone at the hinge 110 and the hinge discontinuity 114 may move the barrier 25 or other features to allow the mobile device 40 to be slid in or out of the phone retention portion 20 case 10 by placing the mobile device 40 between the floor of the case and the lip 120 and pushing or pulling. While this configuration may allow for the insertion and removal of the mobile device 40, the second configuration may also allow for the case 10 to be used as a stand to orient the device in a particular direction.

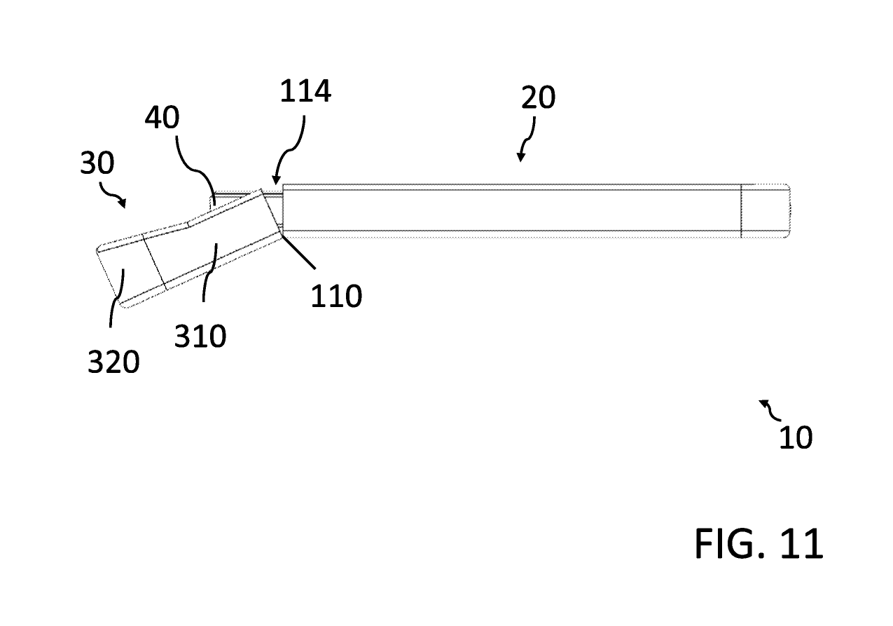

FIG. 11 illustrates a side view of the case 10 of FIG. 8 in the second configuration, including the mobile device 40 emerging from the case 10. In this configuration, the case 10 may be referred to in the context of a first section and a second section divided by the hinge 110 and the hinge discontinuity 114. While in the first configuration, the first and second sections are substantially parallel, while in the second configuration, the first and second sections are rotated with respect to each other and are no longer substantially parallel.

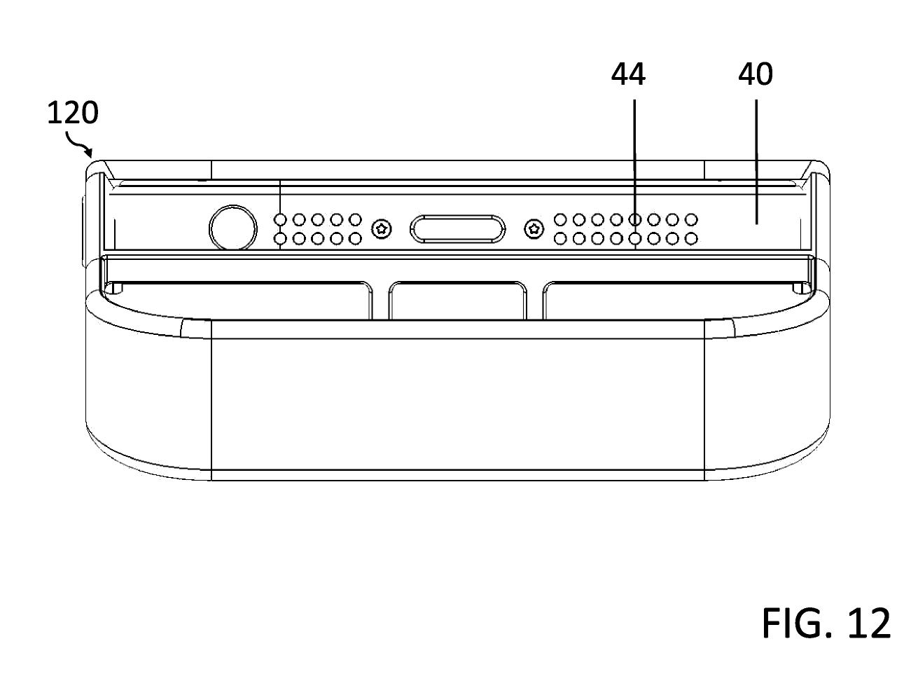

FIG. 12 illustrates an end view of the case 10 of FIG. 8 in the second configuration, including the lip 120. From this perspective and in this configuration, the lip 120 is arranged at the periphery of the enclosure 120. The lip 120 may be a flange that extends over the front of the mobile device 40 to restrict motion while minimizing any negative effects on the usability of the screen or other controls on the front of the device 40. This may be accomplished by extending the lip 120 over a bezel of the mobile device 40. In this second configuration, the barrier 25 is moved out of the way of the mobile device 40 and no longer blocks motion of the mobile device 40. Also shown in this front view are the speaker 42, the microphone 44, the port 46, and the audio connector 48.

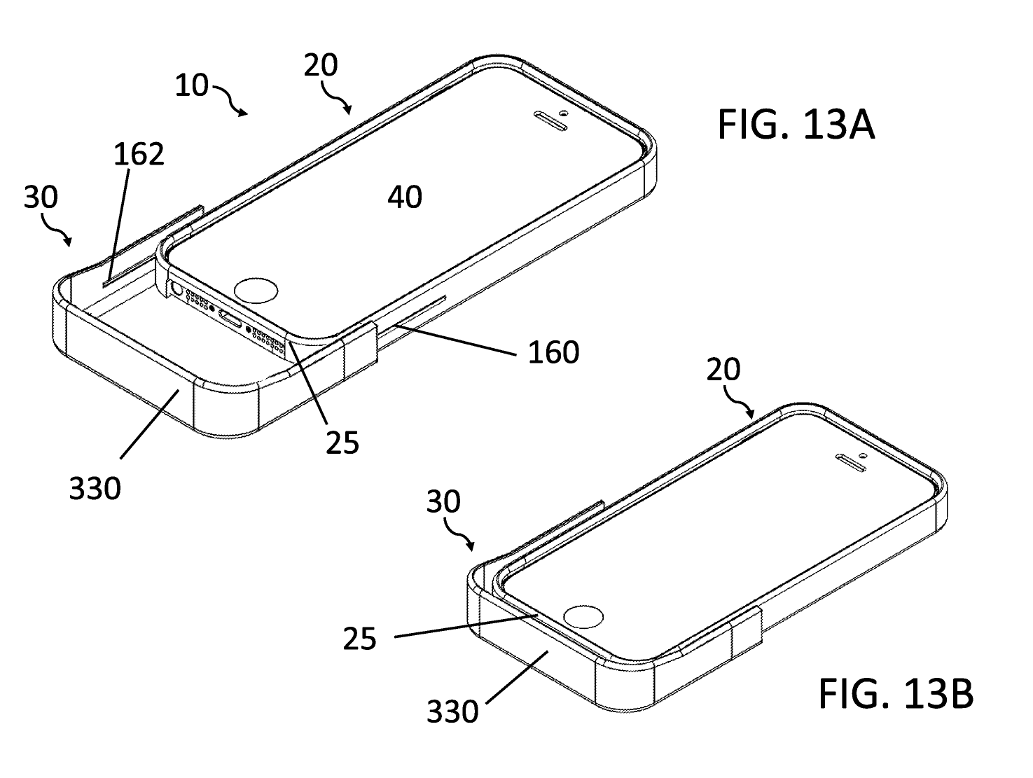

FIGS. 13A and 13B illustrate the case 10 according to certain implementations where the radiator 30 is slidably coupled to the mobile device enclosure 180 near the sound input opening 34 to define a first position in FIG. 13A and where the sound wall 330 is spaced further apart from the sound input opening 34 compared to a second position in FIG. 13B.

More particularly, FIG. 13A illustrates a case 10 where the radiator 30 is in a first deployed position according to certain implementations. For instance, the radiator 30 may be in the first deployed position as a result of a sliding fit between tongue 162 and groove 160. This position may be an extended or substantially extended position where the sound wall 330 is substantially distant from the barrier 25. While in this position, the radiator 30 may amplify, direct, or otherwise modify sound emitted from the mobile device 40.

FIG. 13B illustrates the case 10 where the radiator 30 is in a second retracted position according to certain implementations. In FIG. 13B, the radiator may be in the second retracted position as a result of sliding the sound wall 330 towards the barrier 25 until the components are substantially adjacent. While in this configuration, the radiator 30 may amplify, direct, or otherwise modify the sound emitted from the mobile device 40; however, it may have additional or changed characteristics from the first deployed position. For example, certain frequencies of sound may be accentuated or diminished. In certain configurations, the sound may be muffled or muted altogether by substantially sealing barrier 25 with sound wall 330.

In addition to amplifying and directing sound from the speaker 42, the radiator 30 may also be suitable for acting as a channel, wind blocker, or other sound enhancer for directing external sound into the microphone 44.

While the radiator 30 has been discussed in the context of case 10, radiator 30 need not be integrally connected with the mobile device portion 20 and may be sold or utilized as a separate component that is adapted to fit or cooperate with existing case designs from a variety of manufacturers. For example, certain implementations of radiator 30 may include a radiator floor 340, sound wall 330, and radiator side walls 310, but it may also include one or more connection members for connecting the radiator 30 to a mobile phone enclosure so that the sound input opening is located near a speaker opening in the mobile phone enclosure. The connection members may be elongated components extending from side walls 310 or they may be the side walls 310 themselves in an elongated configuration in order to fit around or cooperate with an existing case design.

While this disclosure describes exemplary cases, various changes can be made and equivalents may be substituted without departing from the spirit and scope thereof. As understood by those skilled in the art, modifications can also be made to adapt these teachings to different situations and applications, and to the use of other materials and methods, without departing from the essential scope of the cases disclosed herein. Implementations are thus not limited to the particular examples that are disclosed, and encompasses all of the implementations falling within the subject matter of the appended claims.

What is claimed is:

1. A case for a mobile device comprising:
a mobile device enclosure comprising a pair of adjacent side walls coupled by a pair of adjacent end walls defining a substantially elongate rectangular opening configured to receive a mobile device, wherein an end wall of the pair of end walls defines a sound input opening; and
a sound radiator coupled to the mobile device enclosure proximate the end wall defining the sound input opening,
wherein the radiator includes components comprising side walls, shoulders, a sound wall and a radiator floor,
wherein a first end of the radiator side walls extend perpendicularly relative to the end wall defining the sound input opening,
wherein the shoulders extend from a second end of the radiator side walls,
wherein the sound wall is joined between the shoulders and is arranged opposite the end wall defining the sound input opening,
wherein the radiator floor defines a cover such that the radiator components define a partial enclosure for receiving and directing sound waves, and
wherein the side walls and the sound wall define a sound output opening acoustically coupled to the sound input opening for transmitting sound waves out of the partial enclosure.

2. The case of claim 1, wherein the radiator is slidably coupled to the mobile device enclosure proximate the sound input opening to define, wherein in a first position, the radiator sound wall is spaced apart from the sound input opening such that the radiator is in an open position, and wherein in a second position, the radiator sound wall is adjacent the sound input opening such that the radiator is in a closed position.

3. A case for a mobile device comprising:
a mobile device enclosure; and
a barrier defining a sound input opening and dividing the mobile device enclosure into a device portion and a sound radiator,
wherein the radiator comprises side walls extending from terminal ends of the barrier, a sound wall extending between the side walls, and a radiator floor joined to the side walls and the sound wall,
wherein the side walls and the sound walls define a sound output opening acoustically coupled to the sound input opening.

4. The case of claim 3, wherein the mobile device further comprises:
a hinge that divides the case into a first section and a second section; and
a hinge discontinuity located substantially between the first and second sections.

5. The case of claim 4, wherein the hinge defines a first position where the first and second sections are substantially parallel and a second position where the first and second sections are not substantially parallel.

6. The case of claim 3, wherein the radiator is slidably coupled to the mobile device enclosure proximate the sound input opening to define a first position where the sound wall is further away from the speaker opening than it is in a second position.

7. The case of claim 3, wherein the height of the radiator floor is equal to a height of the walls.

8. The case of claim 3, wherein the radiator floor is made from a different material than the other components of the radiator.

9. The case of claim 3, wherein the radiator floor is constructed from a resonant material.

10. The case of claim 3, wherein the radiator floor extends partially into the phone enclosure.

11. The case of claim 3, wherein the radiator is detachable from the phone enclosure.

12. A radiator comprising:
a radiator floor and, extending therefrom, a sound wall and a side wall;
a sound input opening and a sound output opening defined by the sound wall, side wall, and radiator floor; and
one or more connection members for connecting the radiator to a mobile phone enclosure such that the sound input opening is located near a speaker opening in the mobile phone enclosure,
wherein the sound output opening is larger than the sound input opening.

13. The radiator of claim 12, wherein the radiator floor has an increased height near the where a portion where the walls extend from the radiator floor.

14. The radiator of claim 12, wherein the height of the radiator floor is equal to a height of the walls.

15. The radiator of claim 12, wherein the radiator floor is made from a different material than the other components of the radiator.

16. The radiator of claim 12, wherein the radiator floor is constructed from a resonant material.

17. The radiator of claim 12, wherein the radiator floor extends partially into the phone enclosure.

18. The radiator of claim 12, wherein the radiator is detachable from the phone enclosure.
